(19) United States
(12) Patent Application Publication
(10) Pub. No.: US 2009/0217278 A1
(43) Pub. Date: Aug. 27, 2009

(54) PROJECT MANAGEMENT SYSTEM

(75) Inventors: Alexander D. CHAFFEE, San Francisco, CA (US); Robert C. MEE, San Francisco, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: PIVOTAL LABS, INC., San Francisco, CA (US)

(21) Appl. No.: 12/466,327

(22) Filed: May 14, 2009

Related U.S. Application Data
(63) Continuation of application No. 11/676,210, filed on Feb. 16, 2007.

(51) Int. Cl. G06F 9/46

(52) U.S. Cl. 718/103; 718/102

(57) ABSTRACT

A method and apparatus for managing a project are described. According to one embodiment, the method includes the steps of ranking the plurality of tasks to produce a first list; assigning a task cost to each of the plurality of tasks; setting a planned velocity, the planned velocity determining the rate at which task costs are planned to be completed per time segment; and dynamically assigning each of the plurality of tasks to one of the sequence of time segments in the order indicated by the first list based on the planned velocity. In other embodiments, the apparatus includes a machine-readable medium that provides instructions for a processor, which when executed by the processor cause the processor to perform a method of the present invention.

### CLAIM OF PRIORITY

The present application is a continuation application of U.S. patent application Ser. No. 11/676,210, filed Feb. 16, 2007, the disclosure of which is incorporated herein by reference.

### BACKGROUND

1. Field of the Invention

This invention relates generally to the field of project management. More particularly, the invention relates to a method and apparatus for managing tasks.

2. Description of the Related Art

Project management systems allow users to manage tasks and track progress of a project.

In some project management systems, users enter tasks and information about each task such as when the task is scheduled to be started, the expected duration, and whether a task can be started before certain other tasks are completed. As the project proceeds, these task characteristics often change. Establishing this information and maintaining the currency of this information can demand a significant amount of work. In some embodiments, this work results in insufficient benefit to project management to justify the additional work.

In other project management systems, users enter tasks in a simple “to do” list. As the project proceeds, completed tasks are marked as completed. While maintaining a “to do” list requires minimal work, the ability to track progress towards project milestones is limited.

What is needed is a project management system that allows for tracking project milestones but requires less maintenance work.

### SUMMARY

A method and apparatus for managing a project are described. According to one embodiment, the method includes the steps of ranking the plurality of tasks to produce a first list; assigning a task cost to each of the plurality of tasks; setting a planned velocity, the planned velocity determining the rate at which task costs are planned to be completed per time segment; and dynamically assigning each of the plurality of tasks to one of the sequence of time segments in the order indicated by the first list based on the planned velocity. In other embodiments, the apparatus includes a machine-readable medium that provides instructions for a processor, which when executed by the processor cause the processor to perform a method of the invention.

### BRIEF DESCRIPTION OF THE DRAWINGS

These and other features, aspects, and advantages of the present invention will become better understood with regard to the following description, appended claims, and accompanying drawings where:

FIG. 1 shows a block diagram of one embodiment of a list assigned to time segments.

FIG. 2 shows a block diagram of one embodiment of a list assigned to time segments.

FIG. 3 shows a block diagram of one embodiment of a list assigned to time segments.

FIG. 4 shows a block diagram of one embodiment of a list assigned to time segments.

FIG. 5 illustrates a block diagram of a sequence of time segments according to an embodiment of the invention.

FIG. 6 is a flow chart of one embodiment of a method of the invention.

FIG. 7 is a block diagram of one embodiment of a system of the present invention.

FIG. 8 is a diagrammatic representation of a machine of the present invention in the exemplary form of a computer system.

### DETAILED DESCRIPTION OF PREFERRED EMBODIMENTS

At least some embodiments of the disclosure relate to a method and apparatus for managing projects.

The following description and drawings are illustrative and are not to be construed as limiting. Numerous specific details are described to provide a thorough understanding of the disclosure. However, in certain instances, well known or conventional details are not described in order to avoid obscuring the description. References to one or an embodiment in the present disclosure can be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

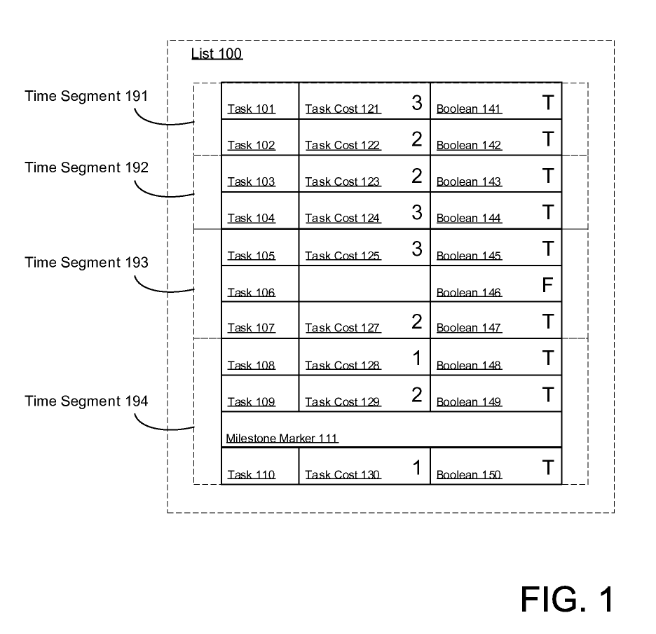

FIG. 1 illustrates one embodiment of a list of the present invention. In one embodiment, a user ranks tasks to create a list in an order that the tasks are planned to be performed and inserts milestone markers in the list to track when all prior tasks are expected to be completed. The ranking can depend on several factors including which tasks logistically need to be done first, the relative costs of tasks in terms of critical resources, and the relative importance of tasks.

A list 100 comprises a task 101, a task 102, a task 103, a task 104, a task 105, a task 106, a task 107, a task 108, a task 109, a task 110 and a milestone marker 111. Some tasks have a task cost that indicates the resources required to complete the task relative to the other tasks in the list 100. In some embodiments, the resources are the labor required to complete the task. In other embodiments, the resources are the capital required to complete the task. In yet other embodiments, the resources are some combination of labor and capital required to complete the task.

In one embodiment, the specification of task costs is meant to be a rough indication of resources required based on past task execution experience. In another embodiment, more rigorous methods may be used to specify task costs. In one embodiment, the task costs are meant to be an indication of the amount of a subset of resources required to complete the task relative to the amount of that subset of resources required for other tasks in the list. For example, in a case where software coding labor is the limiting resource, task costs may be an indication of the relative software coding labor required to complete the task even though other labor and capital is also required to complete the task. A user can decide how to balance the tradeoff between the accuracy, precision and currency of task cost estimation and the overhead work required in estimating and maintaining task costs.

In one embodiment, a user assigns the task costs to tasks by specifying an integer value. For example, a task assigned a task cost of five would be expected to take five times as much resources as a task assigned a task cost of one. In one embodiment, the user selects one of a predetermined set of integers. In another embodiment, real numbers can be used to specify relative resource requirements.

A planned velocity is used to indicate the rate at which tasks costs are completed per time segment. Each time segment corresponds to a uniform period of time, such as one week. A sequence of time segments covers the period of the planned project.

In FIG. 1, the planned velocity is five. Each task is dynamically assigned in the order of the list 100 to a sequence of time segments. The velocity for each time segment is the sum of the task costs of all the tasks in that time segment in the order of the list 100.

In one embodiment, tasks are assigned to a segment until assigning the next task in the list 100 would make the velocity for that segment exceed the planned velocity. In another embodiment, some tasks have task costs and others do not have task costs. Tasks that do not have task costs are assigned to the same segment as the next higher priority task (in the list order) that has a task cost.

Each element of the list 100 is associated with one of four time segments: a time segment 191, a time segment 192, a time segment 193 and a time segment 194. The task 101 and the task 102 are dynamically assigned to the time segment 191. The task 103 and the task 104 are dynamically assigned the time segment 192. The task 105, the task 106 and the task 107 are dynamically assigned the time segment 193. Note that each of these time segments has a velocity of five and if the next task was assigned to the respective time segment, the velocity of the time segment would have exceeded the planned velocity of five. The task 108 and the task 109, and the task 110 are dynamically assigned to the time segment 194.

The task 106 and a milestone marker 111 have no task costs and are assigned to the same time segment as the prior task in the list 100. In one embodiment, tasks without task costs may be tasks that are ancillary to the project goals. For example, ancillary tasks may be bug fixes in a software development project. In one embodiment, the milestone marker 111 is meant to track the time segment in which all higher priority tasks in the list 100 are expected to be completed. In the illustrated embodiment, the system would report that the milestone marker 111 is in the time segment 194, the fourth time segment in the sequence of time segments.

Dynamic assignment of task costs to time segments relieves the user of the task of manual assignment. If the user changes the planned velocity, the system dynamically reassigns the tasks in the list 100 to time segments by limiting the velocity of each segment to the new planned velocity. If the task cost of a task is changed by the user, the system can automatically reassign that task and the tasks following that task in the list 100 to time segments according to the planned velocity. If new tasks are inserted into the list 100 or the order of the list 100 is changed, the system can dynamically assign the tasks in the list 100 to time segments based on the planned velocity.

As the tasks are dynamically reassigned to time segments, the milestone markers may be assigned to different time segments. By tracking the shifts in milestone markers, a project manager can quickly get a sense of the project status against the project plan and manage the project accordingly. The number of uncompleted time segments can change depending on how many are required to allocate the tasks to time segments according to the dynamic assignment method used.

The sequence of time segments can include completed time segments and uncompleted time segments. The velocity of completed time segments can be used to determine the planned velocity for the uncompleted time segments.

In one embodiment, the planned velocity is a moving average of the velocity of one or more of the most recently completed time segments. The velocity of completed time segments is based on the task costs of tasks actually completed during the corresponding period of the project. As additional time segments are completed, the planned velocity is dynamically updated and the uncompleted tasks are reassigned to uncompleted time segments based on the updated planned velocity.

In another embodiment, the planned velocity is the median of the velocities of two or more of the most recently completed time segments. In yet another embodiment, the planned velocity is projected from a trend line based on the velocities of two or more of the most recently completed time segments. The trend line may be based on a linear or non-linear fit of the velocities of the most recently completed time segments. In one embodiment, the planned velocity for all uncompleted time segments is set to the value of the trend line extended into the current time segment. In another embodiment, the planned velocity varies for each time segment in the sequence of uncompleted time segments based on the projection of the trend line into the corresponding time segment. Other methods of setting a planned velocity may be used.

In another embodiment, the planned velocity is entered by the user. For example, a planned velocity entered by the user may be used as a default planned velocity until there is a track record of completed time segments or used to override the computed planned velocity to determine the timing of the milestones based on a change in resources allocated to the project as represented by the changed planned velocity.

In some embodiments, each task cost also has a boolean to classify the task. In some embodiments, the boolean specifies whether the task is considered to have “value” to the output of the project. Tasks 101-110 have a corresponding set of Booleans 141-150. For example, the boolean 141 is “T” for true and indicates that the task 101 has “value” whereas the boolean 146 is “F” for false and indicates that the task 106 does not have “value.”

These classifications can be defined based on the project context. For example, in software development projects, tasks related to developing software features can be classified as having “value” whereas tasks related to fixing bugs and other chores related to project maintenance can be classified as not having value. In some sense, fixing bugs has value to the output of the project in that software without bugs is more valuable than software with bugs, but fixing bugs can also be viewed as an ancillary maintenance task of addressing problems with the execution of previous tasks.

By making this distinction, the computation of velocity of the project can be made to distinguish between tasks that directly contribute to customer value of the project output and tasks that are ancillary. In one embodiment, only those tasks that have “value” are included in the computation of velocity for completed time segments and the computation of planned velocity. In some embodiments, tasks that do not have “value” do not have a task cost.

In other embodiments, tasks without a “value” do have a task cost. In some embodiments, the planned velocity is computed using only tasks costs from tasks that have “value” and the velocity of uncompleted time segments include the tasks that don't have “value” in recognition that these tasks that don't have value still consume project resources.

In some embodiments, the rationale for distinguishing between tasks that are counted in the velocity computation and tasks that are not can be defined based on other distinctions instead of whether the task has value. In yet other embodiments, all tasks count toward the computation of velocity of completed segments and the planned velocity computation.

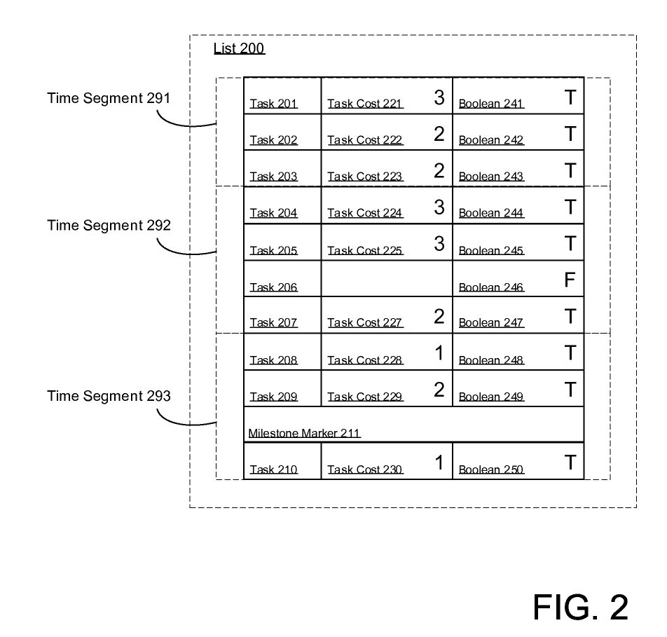

FIG. 2 illustrates another embodiment of a list of the present invention. List 200 is similar to list 100 except that the assignment of tasks to the time segments is based on a planned velocity of eight instead of a planned velocity of five. A task 201, a task 202 and a task 203 are dynamically assigned to a segment 291. A task 204, a task 205 a task 206 and a task 207 are dynamically assigned to a segment 292. A task 208, a task 209, a task 210 and a milestone marker 211 are dynamically assigned to a segment 293.

The milestone marker 211 is now assigned to the third time segment in the sequence of time segments as compared to the list 100 in which the milestone marker 111 is assigned to the fourth time segment in the sequence of time segments. The milestone is expected to be achieved sooner given that the planned velocity has increased.

The tasks 201-210 have corresponding booleans 241-250 that classify the tasks according to one of two categories. In one embodiment, “T” (true) indicates that the task has a task cost whereas “F” (false) indicates the task does not have a task cost.

As the project proceeds, these same time segments that were processed as uncompleted time segments are then processed as completed time segments. For example, when the time segment 292 is a completed time segment, the tasks assigned to that time segment are those that were completed when that time segment was the current time segment.

When the time segment is completed, the velocity of the time segment may be relevant for dynamic computation of the planned velocity. The time segment 292 includes the task 204, the task 205 and the task 206. In one embodiment, the velocity of the time segment 292, when it is a completed time segment, would be the sum of the task cost 224 and the task cost 225. The sum for the velocity of the time segment 292 would not include a task cost for task 206.

In some embodiments, the planned velocity is the moving average of one or more recently completed time segments. A moving average of less time segments results in a planned velocity that is more responsive to the velocity of the most recently completed time segment. A moving average of more time segments results in a more stable planned velocity.

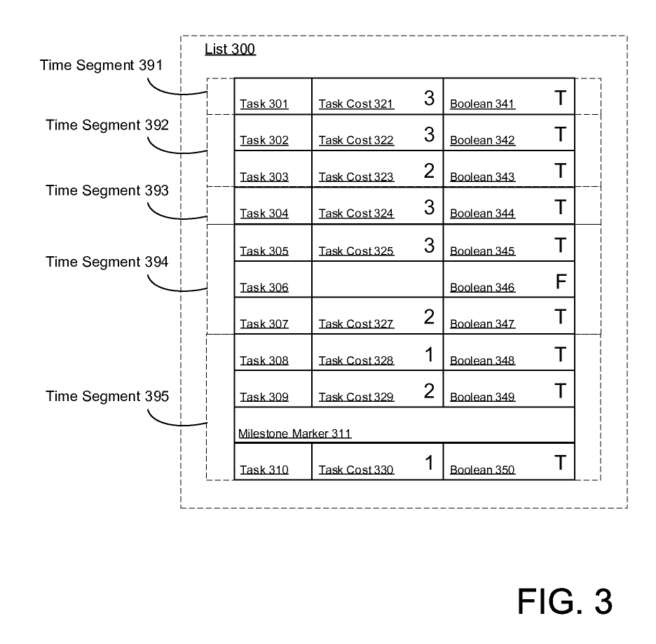

FIG. 3 illustrates another embodiment of a list of the present invention. List 300 is similar to list 100 except that the task cost corresponding to the second task in the list is changed from two to three.

A task 301 is dynamically assigned to a time segment 391. Even though the velocity of the first time segment is three and the planned velocity is five, the next task in the list 300, the task 302, is not assigned to the time segment 391 because that would cause the time segment 391 to have a velocity of six, exceeding the planned velocity of five.

A task 302 and a task 303 are dynamically assigned to a time segment 392. The next task in the list 300, the task 304, is not assigned to the time segment 392 because that would cause the time segment 392 to have a velocity of eight, exceeding the planned velocity.

A task 304 is dynamically assigned to a time segment 393. The next task in the list, the task 305, is not assigned to the time segment 393 because that would cause the time segment 393 to have a velocity of six, exceeding the planned velocity.

A task 305, a task 306 and a task 307 are dynamically assigned to a time segment 394. The next task in the list 300, the task 308, is not assigned to the time segment 394 because that would cause the time segment 394 to have a velocity of six, exceeding the planned velocity.

A task 308, a task 309, a milestone marker 311 and a task 310 are dynamically assigned to a time segment 395.

The milestone marker 311 is assigned to the fifth time segment in the sequence of time segments as compared to the list 100 in which the milestone marker 111 is assigned to the fourth time segment in the sequence of time segments. The milestone is expected to be achieved later given that the task cost of the second task in the list has increased.

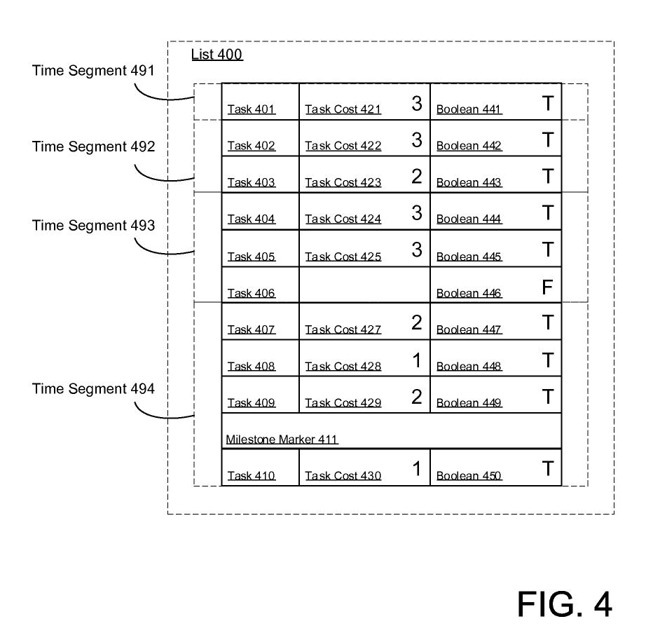

FIG. 4 illustrates another embodiment of a list of the present invention. List 400 is similar to list 300 except that a different dynamic assignment method is used. During the dynamic assignment of tasks to time segments, any unused planned velocity in a particular time segment is carried over and made available in subsequent time segments. This dynamic assignment method recognizes that if the resources represented by the planned velocity would not be fully consumed completing tasks allocated to that segment, those unused resources may be applied to partially complete tasks that are expected to be completed in the following time segment.

At the end of N time segments, the sum of the velocities can be up to N times the planned velocity for any N from one up to the number of time segments in the sequence of uncompleted time segments. For a planned velocity of 5, the velocity in the first time segment is less than or equal to 5. The sum of the velocities in the first two time segments is less than or equal to 10. The sum of the velocities in the first three time segments is less than or equal to 15. And so on.

A task 401 is dynamically assigned to a time segment 491. While the velocity of the first time segment is 3 and the planned capacity is 5, the next task in the list 400, a task 402, is not assigned to the time segment 491 because that would cause the time segment 491 to have a velocity of six, exceeding the planned velocity.

The task 402 and a task 403 are dynamically assigned to a time segment 492. Since the time segment 492 is the second time segment and the planned velocity is 5, tasks can be assigned to this segment such that the velocity of the first two time segments is less than or equal to ten. The next task in the list, the task 404, is not assigned to the time segment 492 because that would cause the first two time segments to have a cumulative velocity of eleven, exceeding two times the planned velocity.

A task 404, a task 405 and a task 406 is dynamically assigned to a time segment 493. Since the time segment 493 is the third time segment and the planned velocity is five, tasks can be assigned to this segment such that the velocity of the first three time segments is less than or equal to fifteen. The task 406 has no task cost and is dynamically assigned to the time segment 493 because the next higher priority task that has a task cost, the task 405, is assigned to the time segment 493. The next task in the list, the task 407, is not assigned to the time segment 492 because that would cause the first three time segments to have a cumulative velocity of sixteen, exceeding three times the planned velocity.

A task 407, a task 408, a task 409, a milestone marker 411 and a task 410 is dynamically assigned to a time segment 494. Since the time segment 494 is the fourth time segment and the planned velocity is five, tasks can be assigned to this segment such that the velocity of the first four time segments is less than or equal to twenty.

The milestone marker 411 is assigned to the fourth time segment in the sequence of time segments as compared to the list 300 in which the milestone marker 311 is assigned to the fifth time segment in the sequence of time segments. The milestone is expected to be achieved earlier given that the different dynamic allocation scheme.

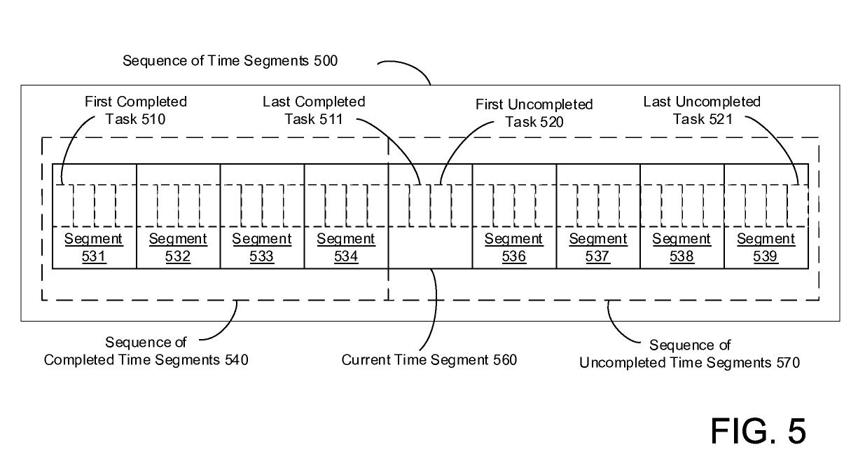

FIG. 5 illustrates one embodiment of a sequence of time segments of the invention.

A sequence of time segments 500 comprises a sequence of completed time segments 540 and a sequence of uncompleted time segments 570. The sequence of completed time segments 540 correspond to periods of time in the past. The time segments in the sequence of completed time segments 540 comprise a segment 531, a segment 532, a segment 533 and a segment 534. The first time segment in the sequence of uncompleted time segments 570 is a current time segment 560. The other time segments in the sequence of uncompleted time segments 530 comprise a segment 536, a segment 537, a segment 538 and a segment 539. The current time segment 560 corresponds to the present time period in the project and the other time segments in the sequence of uncompleted time segments 570 correspond to future time periods in the project.

As time passes beyond the period corresponding to the current time segment 560, the current time segment 560 is completed and is removed from the sequence of uncompleted time segments 570 and appended onto the end of the sequence of completed time segments 540. The segment 536 becomes the current time segment. This process continues in a similar manner until there are no more uncompleted time segments.

There is a list of completed tasks starting with a first completed task 510 and ending with a last completed task 511. As a task is marked completed it is appended to the list of completed tasks after the last completed task 511 and associated with the current time segment 560.

There is a list of uncompleted tasks starting with a first uncompleted task 520 and ending with a last uncompleted task 521. In one embodiment, these tasks are dynamically assigned to the sequence of uncompleted time segments 570 in the order of the list of uncompleted tasks based on the planned velocity. In one embodiment, the planned velocity for the current time segment is first allocated to the completed tasks in that segment in recognition that some of the resources represented by the planned velocity have been consumed completing those tasks in the current time period. The balance of the planned velocity for the current time segment is used to assign the first tasks in uncompleted task list to the current time segment. Tasks in the subsequent uncompleted time segments are assigned in the order of the uncompleted task list based on the planned velocity.

In one embodiment, all tasks in the list of uncompleted tasks are in an unstarted state. As the project proceeds, any task in the list of uncompleted tasks can be changed to a “started” state by the user. Started tasks are prioritized in the uncompleted list to be above all the uncompleted tasks that are not started. Since this action may reorder the list of uncompleted tasks, it can trigger a dynamic reallocation of the uncompleted tasks to the sequence of uncompleted time segments.

Any started task in the list of uncompleted tasks can be changed to a “delivered” state to indicate that the task is completed and awaiting review by one or more stakeholders. A stakeholder can be a customer for the project or someone else with a vested interest in the results. If the stakeholders choose to accept the delivered task, the task is changed to a “completed” state. Completed tasks are removed from the uncompleted list and appended to the completed list and associated with the current time segment. If the stakeholders choose to reject the delivered task, the task returns to the “started” state. The person executing the task is then expected to address the deficiencies and then change the task to a “delivered” state again for another review by one or more stakeholders.

Alternative task management processes can be used. For example, intermediate states may be included between the started state and the delivered state so that task progress can be tracked with more detail. Furthermore, the approval process can be eliminated such that a task that is “delivered” is considered completed.

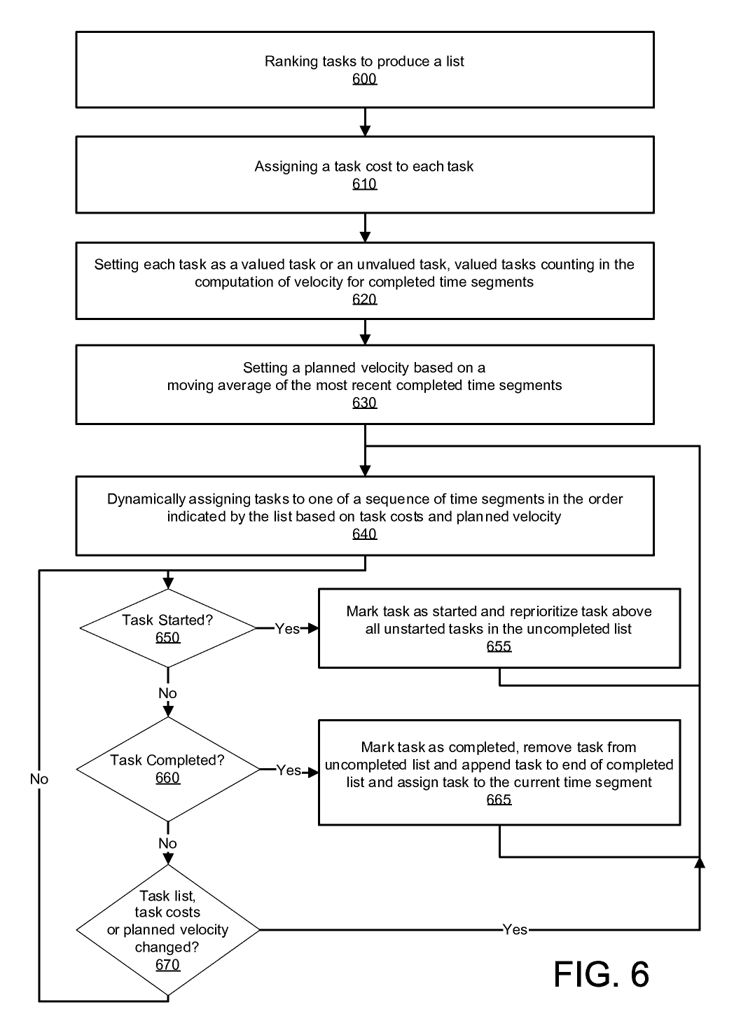

FIG. 6 is a flow diagram illustrating one embodiment of a method of the present invention.

In step 600, tasks are ranked to produce a list. The list indicates the priority in which tasks are planned to be completed. In some embodiments, milestone markers are also inserted into the list to track when certain milestones are expected to be completed.

In step 610, a task cost is assigned to each task. Task costs are an indication of the resources the task is expected to require to complete relative to the other tasks in the task list. In one embodiment, a predetermined set of integers are used. In another embodiment, real numbers are used.

In step 620, each task is categorized as a valued task or an unvalued task. In one embodiment, valued tasks are tasks that have a task cost and unvalued tasks are tasks that do not have a task cost.

In step 630, the planned velocity is computed based on the moving average of the velocity for one or more of the most recently completed time segments. When less time segments are used, the planned velocity is more responsive to the pace of progress in the most recently completed time segment and the project milestones may shift more as each time segment is completed. When more time segments are used, the planned velocity is more stable and the project milestones may shift less as each time segment is completed.

In step 640, tasks are dynamically assigned to one of a sequence of uncompleted time segments in the order indicated by the list based on the task costs and the planned velocity. Examples of dynamic allocation methods are described herein.

In step 650, it is determined whether a task is started. In one embodiment, the user manually indicates that a task is started. In another embodiment, a monitoring process on a computer automatically determines whether a task is started. If the task is started, step 655 is performed. If the task is not started, step 660 is performed.

In step 655, the task is marked as started and reprioritized above all unstarted tasks in the uncompleted list. The dynamic assignment process will now assign this started task to time segments before all unstarted tasks in the uncompleted list.

In step 660, it is determined whether a task is completed. In one embodiment, the user manually indicates that a task is completed. In another embodiment, a monitoring process on a computer automatically determines whether a task is completed. If the task is completed, step 665 is performed. If the task is not started, step 670 is performed.

In step 665, the completed task is marked as completed, removed from the uncompleted task list, appended onto the end of the completed task list, and assigned to the current time segment. This task will remain associated with the time segment that was the current time segment when the task was completed. The dynamic assignment process will not assign this task to time segments because it is no longer in the uncompleted task list. However, while it is in the current time segment, the task cost associated with this completed time segment is allocated some of the planned velocity of the current time segment before the dynamic assigned of the first tasks in the uncompleted task list in recognition that some of the resources in the current time period were consumed completing the tasks completed in that time segment.

In step 670, it is determined whether a change is made that triggers dynamic reassignment of tasks to uncompleted time segments. For example, a change may be made to the task list order, tasks may be inserted into the task list, one or more task costs may be changed or the planned velocity may be changed. In these cases, dynamic assignment of tasks to time segments is triggered. Step 640 is repeated with the adjusted information that triggered the dynamic reassignment of tasks to time segments. If no such triggering events are detected, step 650 is repeated.

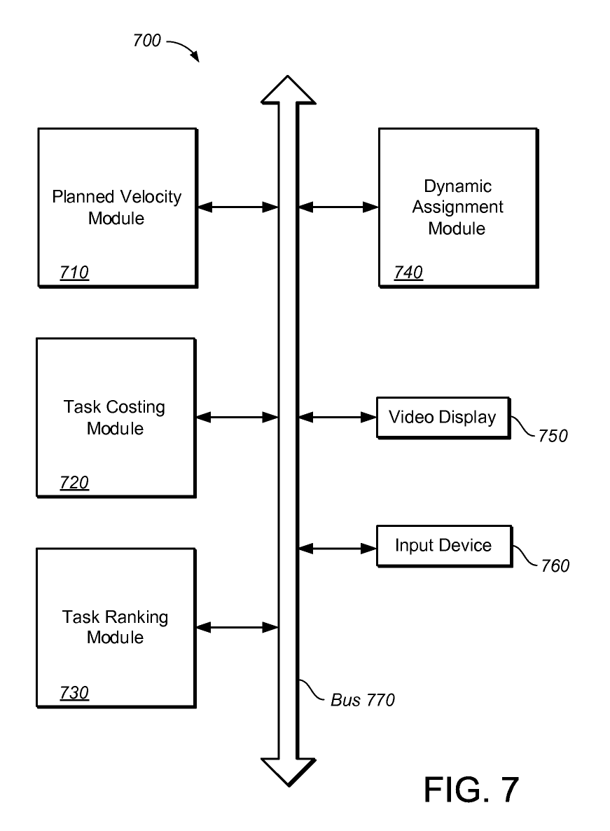

FIG. 7 illustrates a block diagram of one embodiment of a system 700 of the present invention.

The system 700 includes a planned velocity module 710, a task costing module 720, a task ranking module 730, a dynamic assignment module 740, a video display 750 and an input device 760 coupled together through a bus 770.

The task ranking module 730 generates a list of tasks. In one embodiment, the task ranking module 730 generates a list of tasks based on a user specifying and ordering the tasks according to an embodiment of a method illustrated herein.

The task costing module 720 associates task costs with each task. In some embodiments, the task costing module 720 generates the task costs based on a user specifying the task cost associated with each task according to an embodiment of a method illustrated herein.

The planned velocity module 710 generates a list of tasks. In some embodiments, the planned velocity module 710 generates a planned velocity according to a moving average of the velocity of one or more of the most recently completed segments according to an embodiment of a method illustrated herein. In another embodiment, the planned velocity module 710 generates a planned velocity based on a user specifying the planned velocity.

The dynamic assignment module 740 dynamically assigns each of the plurality of tasks to one of the sequence of time segments in the order indicated by the first list based on the tasks costs and the planned velocity. In some embodiments, the dynamic assignment module 740 dynamically assigns each of the plurality of tasks according to one embodiment of a method illustrated herein.

In one embodiment, user input is provided to one or more of the modules using an input device 760. The input device 760 may be a keyboard, cursor control device, or voice recognition system, for example. In another embodiment, more than one input device may be used. In one embodiment, module output is displayed using a video display 750.

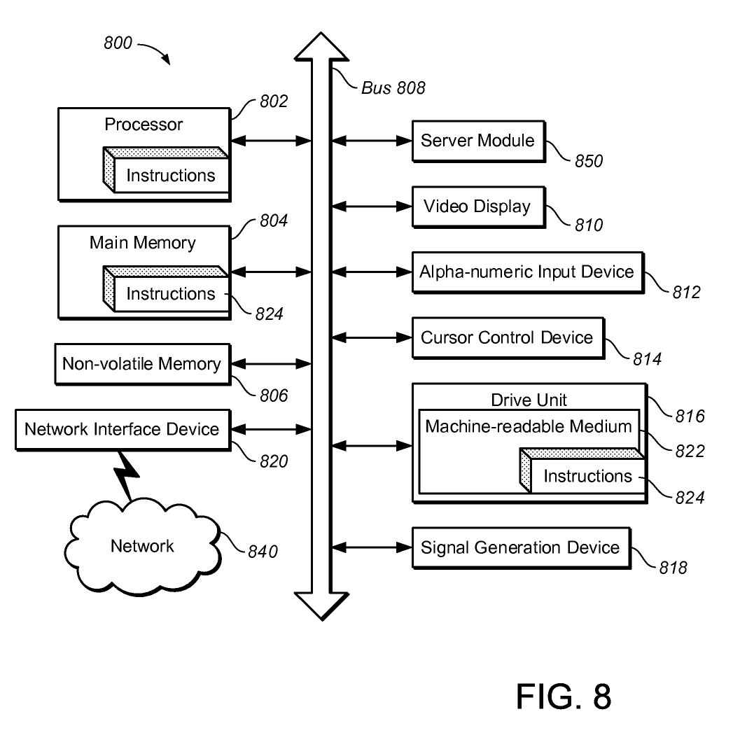

FIG. 8 shows a diagrammatic representation of a machine in the exemplary form of a computer system 800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with the server to facilitate operations of the server and/or to access the operations of the server.

The computer system 800 includes a processor 802 (e.g., a central processing unit (CPU) a graphics processing unit (GPU) or both), a main memory 804 and a nonvolatile memory 806, which communicate with each other via a bus 808. In some embodiments, the computer system 800 may be a laptop computer, personal digital assistant (PDA) or mobile phone, for example. The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a disk drive unit 816, a signal generation device 818 (e.g., a speaker) and a network interface device 820. The disk drive unit 816 includes a machine-readable medium 822 on which is stored one or more sets of instructions (e.g., software 824) embodying any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media. The software 824 may further be transmitted or received over a network 826 via the network interface device 820.

While the machine-readable medium 822 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that the various modification and changes can be made to these embodiments.

Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer implemented method for managing a plurality of tasks in a sequence of time segments, each of the sequence of time segments corresponding to a period of time, the method comprising:
ranking, via a computing device, the plurality of tasks to produce a first list;
assigning a task cost to a first plurality of the plurality of tasks;
setting a planned velocity, the planned velocity determining the rate at which task costs are planned to be assigned per time segment; and
dynamically assigning each of the plurality of tasks to one of the sequence of time segments in the order indicated by the first list based on the tasks costs and the planned velocity.

2. The method of claim 1 wherein each task cost is selected from a predetermined set of integers.

3. The method of claim 1 wherein each task cost is an indication of an amount of resources anticipated to be used to complete the corresponding task in the plurality of tasks relative to other tasks in the plurality of tasks.

4. The method of claim 1 wherein the sequence of time segments comprise a sequence of completed time segments, each of the sequence of completed time segments having a velocity, each velocity being the sum of the task costs for the plurality of tasks assigned to the corresponding completed time segment, the steps of setting the planned velocity comprising computing a moving average of the velocity for at least one of the most recently completed time segments, the planned velocity being set to the moving average of the velocity.

5. The method of claim 1 wherein the sequence of time segments comprise a sequence of completed time segments, each of the sequence of completed time segments having a velocity, each of the sequence of completed time segments having a velocity, each velocity being the sum of the task costs for the plurality of tasks assigned to the corresponding completed time segment, the steps of setting the planned velocity comprising computing a trend line of the velocity for at least one of the most recently completed time segments, the planned velocity being set by projecting the trend line of the velocity.

6. The method of claim 1 further comprising the step of assigning each of the plurality of tasks to either the first plurality of tasks or a second plurality of the plurality of tasks, wherein the sequence of time segments comprise a sequence of completed time segments and a sequence of uncompleted time segments, wherein each time segment in the sequence of completed time segments has a velocity, wherein each velocity is the sum of the task costs of the first plurality of tasks assigned to the corresponding completed time segment.

7. The method of claim 1 wherein the sequence of time segments comprises a sequence of completed time segments and a sequence of uncompleted time segments, wherein each of the uncompleted time segments has a velocity, the velocity for each of the uncompleted time segments being less than or equal to the planned velocity.

8. The method of claim 1 wherein the sequence of time segments comprises a sequence of completed time segments and a sequence of uncompleted time segments, wherein each of the uncompleted time segments has a velocity, the sum of the velocities for the first N uncompleted time segments being less than or equal to N times the velocity for any N from one up to the number of uncompleted time segments.

9. The method of claim 1 wherein the sequence of uncompleted time segments comprise a plurality of started tasks and a plurality of unstarted tasks, the steps further comprising:
indicating that a task in the plurality of unstarted tasks is started; and
in response to indicating that the task is started:
marking the task as started;
prioritizing the task in the first list above all of the plurality of unstarted tasks; and
dynamically reassigning at least one of the plurality of tasks to one of the sequence of time segments in the order indicated by the first list based on the tasks costs and the planned velocity.

10. The method of claim 1 wherein the sequence of time segments comprise a sequence of uncompleted time segments, a current time segment being the first time segment in the sequence of uncompleted time segments, the steps further comprising:
indicating that a task of the plurality of tasks is completed; and
in response to indicating that the task is completed:
removing the task from the first list;
appending the task to the end of a second list;
assigning the task to the current time segment; and
dynamically reassigning at least one of the plurality of tasks to one of the sequence of time segments in the order indicated by the first list based on the tasks costs and the planned velocity.

11. The method of claim 1 further comprising:
changing the order of the first list, one of the task costs or the planned velocity; and
in response to changing the order of the first list, one of the task costs or the planned velocity, dynamically reassigning at least one of the plurality of tasks to one of the sequence of time segments in the order indicated by the first list based on the tasks costs and the planned velocity.

12. A machine-readable medium that provides instructions for a processor, which when executed by the processor cause the processor to perform a method managing a plurality of tasks in a sequence of time segments, each of the sequence of time segments corresponding to a period of time, the method comprising:
ranking the plurality of tasks to produce a first list;
assigning a task cost to each of a first plurality of the plurality of tasks;
setting a planned velocity, the planned velocity determining the rate at which task costs are planned to be assigned per time segment; and
dynamically assigning each of the plurality of tasks to one of the sequence of time segments in the order indicated by the first list based on the planned velocity.

13. The machine-readable medium of claim 12 wherein each task cost is selected from a predetermined set of integers.

14. The machine-readable medium of claim 12 wherein each task cost is an indication of an amount of resources anticipated to be used to complete the corresponding task in the plurality of tasks relative to other tasks in the plurality of tasks.

15. The machine-readable medium of claim 12 wherein the sequence of time segments comprise a sequence of completed time segments, each of the sequence of completed time segments having a velocity, each of the sequence of completed time segments having a velocity, each velocity being the sum of the task costs for the plurality of tasks assigned to the corresponding completed time segment, the steps of setting the planned velocity comprising computing a moving average of the velocity for at least one of the most recently completed time segments, the planned velocity being set to the moving average of the velocity.

16. The machine-readable medium of claim 12 wherein the sequence of time segments comprise a sequence of completed time segments, each of the sequence of completed time segments having a velocity, each of the sequence of completed time segments having a velocity, each velocity being the sum of the task costs for the plurality of tasks assigned to the corresponding completed time segment, the steps of setting the planned velocity comprising computing a trend line of the velocity for at least one of the most recently completed time segments, the planned velocity being set by projecting the trend line of the velocity.

17. The machine-readable medium of claim 12 further comprising the step of assigning each of the plurality of tasks to either the first plurality of tasks or a second plurality of the plurality of tasks, wherein the sequence of time segments comprise a sequence of completed time segments and a sequence of uncompleted time segments, wherein each time segment in the sequence of completed time segments has a velocity, wherein each velocity is the sum of the task costs of all of the first plurality of tasks assigned to the corresponding completed time segment.

18. The machine-readable medium of claim 12 wherein the sequence of time segments comprises a sequence of completed time segments and a sequence of uncompleted time segments, wherein each of the uncompleted time segments has a velocity, the velocity for each of the uncompleted time segments being less than or equal to the planned velocity.

19. The machine-readable medium of claim 12 wherein the sequence of time segments comprises a sequence of completed time segments and a sequence of uncompleted time segments, wherein each of the uncompleted time segments has a velocity, the sum of the velocities for the first N uncompleted time segments being less than or equal to N times the velocity for any N from one up to the number of uncompleted time segments.

20. A computer system for managing a plurality of tasks in a sequence of time segments, each of the sequence of time segments corresponding to a period of time, the system comprising:
a first module configured to rank the plurality of tasks to produce a first list;
a second module configured to assign a task cost to each of a first plurality of the plurality of tasks;
a third module configured to set a planned velocity, the planned velocity determining the rate at which task costs are planned to be completed per time segment; and
a fourth module coupled to the first module, the second module and the third module, the fourth module configured to dynamically assign each of the plurality of tasks to one of the sequence of time segments in the order indicated by the first list based on the planned velocity.
